(19) United States
(12) Patent Application Publication
(10) Pub. No.: US 2022/0191772 A1
(43) Pub. Date: Jun. 16, 2022

(54) Method for Network Identification Dissemination

(71) Applicant: ZTE Corporation, Shenzhen (CN)

(72) Inventors: Wenting LI, Shenzhen (CN); He HUANG, Shenzhen (CN); Yuan GAO, Shenzhen (CN)

(73) Assignee: ZTE Corporation, Shenzhen (CN)

(21) Appl. No.: 17/682,947

(22) Filed: Feb. 28, 2022

Related U.S. Application Data
(63) Continuation of application No. PCT/CN2019/109533, filed on Sep. 30, 2019.

(51) Int. Cl. H04W 48/08; H04W 48/18

(52) U.S. Cl. CPC H04W 48/08; H04W 48/18

(57) ABSTRACT

This disclosure relates to mobile core network information dissemination by a wireless access network node to wireless terminal devices to assist the wireless terminal devices to perform manual core network selection. In particular, a multi-stage process is disclosed for dissemination of human readable network names for core networks supported by a wireless access network node. A human readable name presence indicator may be disseminated with network IDs of the supported core networks. Actual human readable names may be separately disseminated by the wireless access network node either spontaneously or on demand in response to requests from the wireless terminal devices.

### TECHNICAL FIELD

This disclosure is directed to core network identity and capability dissemination to wireless terminal devices from a radio access network node shared by multiple non-public and/or public core networks.

### BACKGROUND

The carrier network portion of a wireless communication system may include geographically distributed radio access networks for providing over-the-air access to fixed or mobile wireless terminal devices, and core networks for routing data traffic among radio access networks or between radio access networks and other data networks external to the core networks. The wireless access networks may be connected to the core networks via wired backhaul connections. The radio access networks may rely on cellular technologies to reuse radio resources and may include a plurality of wireless access network nodes. A radio access network node may be connected to and shared by multiple core networks. These core networks may include both public and non-public core networks. Each core network may be identified by a unique network ID or a unique combination of network IDs. A wireless terminal device may be preconfigured with capability to access a set of public and/or private core networks. The wireless terminal device may be configured to automatically or manually search and select a core network to carry its data traffic. Each core network, a private core network in particular, may optionally be further associated with a human readable network name in addition to its unique network ID. A wireless access network node of a radio access network may disseminate the network IDs and the optional human readable network names of the core networks sharing the wireless access network node to wireless terminal devices. The human readable network names may be used by wireless mobile terminals to facilitate manual selection of servicing core networks.

### SUMMARY

This disclosure relates to mobile core network information dissemination by a wireless access network node to wireless terminal devices to assist the wireless terminal devices to perform manual core network selection. In particular, a multi-stage process is disclosed for dissemination of human readable network names for core networks supported by a wireless access network node. A human readable name presence indicator may be disseminated with network IDs of the supported core networks. Actual human readable names may be separately disseminated by the wireless access network node either spontaneously or on demand in response to requests from the wireless terminal devices.

In one implementation, a method performed in a wireless access network node is disclosed. The method may include generating a core-network availability system information message comprising: a first network identifier corresponding to a first core network that connects to the wireless access network node; and a first network name presence indicator data field corresponding to the first core network. The method may further include broadcasting the core-network availability system information message to wireless user terminal devices via a first predefined over-the-air (OTA) signaling interface, wherein the first network name presence indicator data field notifies the wireless user terminal devices whether a first human readable network name (HRNN) corresponding to the first core network is obtainable from a separate system information message transmitted by the wireless access network node.

In another implementation, a method performed by a wireless terminal device is disclosed. The method may include searching for service availability of a predetermined list of private core networks to identify a subset of available private core networks among the predetermined list of private core networks; identifying a wireless access network node that is available to provide network connection to one or more of the subset of available private core networks; receiving a core-network availability system information message broadcasted from the wireless access network node. The core-network availability system information message comprises a set of network identifiers corresponding to the one or more of the subset of available private core networks; and a set of network name presence indicator data fields. The method may further include determining, based on the set of network name presence indicator data fields and the set of network identifiers, which of the one or more of the subset of available private core networks are associated with human readable network names (HRNNs) obtainable from an HRNN system information message transmitted by the wireless access network node separately from the core-network availability system information message.

In another implementation, a method performed by wireless terminal device is disclosed. The method may include searching for service availability of a predetermined list of private core networks to determine a subset of available private core networks among the predetermined list of private core networks; selecting a wireless access network node available to provide network connection to of the subset of available private core networks; receiving a core-network availability system information message broadcasted from the wireless access network node. The core-network availability system information message may include a network identifier corresponding to the one of the subset of available private core networks; and one of a voice/IMS emergency support indicator data field corresponding to the one of the subset of available private core networks and indicating whether a voice or IMS emergency service is supported by the one of the subset of available private core networks; an eCall-over-IMS support indicator data field corresponding to the one of the subset of available private core networks and indicating whether an eCall-over-IMS service is supported by the one of the subset of available private core networks; or a network slicing support indicator data field corresponding to the one of the subset of available private core networks and indicating whether a network slicing service is supported by the one of the subset of available private core networks. The method may further include determining, based on the network identifiers, and one of the voice/IMS emergency support indicator data field, the eCall-over-IMS support indicator data field, or the network slicing support indicator data field, whether the one of the subset of available private core networks support the voice or IMS emergency service, the eCall-over-IMS service, or the network slicing service; and extracting the voice/IMS emergency support indicator data field, the eCall-over-IMS support indicator data field, or the network slicing support indicator data field from the core-network availability system information message and forwarding to an upper layer in the wireless terminal device for further processing.

In some other implementations, a communication device is disclosed. The communication device main include one or more processors and one or more memories, wherein the one or more processors are configured to read computer code from the one or more memories to implement any one of the methods above.

In yet some other implementations, a computer program product is disclosed. The computer program product may include a non-transitory computer-readable program medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows an example configuration for multiple public and non-public core networks to share radio access networks in providing network access to wireless terminal devices.

FIG. 2 shows an example configuration of various signaling interfaces for communicating network identities and human readable network names from a shared radio access network to wireless terminal devices.

FIG. 3 shows an example logic and data flow for manual selection of non-public core network in a wireless terminal device.

FIG. 4 shows another example logic and data flow for manual selection of non-public core network in a wireless terminal device.

FIG. 5 shows another example logic and data flow for manual selection of non-public core network in a mobile terminal device.

FIG. 6 shows an example logic and data flow for handling service availability of voice or IMS emergency service provided by a non-public core network in a wireless terminal device by various processing layers of the wireless terminal device.

FIG. 7 shows an example logic and data flow for handling service availability of eCall-over-IMS service provided by a non-public core network in a wireless terminal device by various processing layers of a mobile terminal device.

FIG. 8 shows an example logic and data flow for handling service availability of network slicing service provided by a non-public core network in a wireless terminal device by various processing layers of the wireless terminal device.

### DETAILED DESCRIPTION

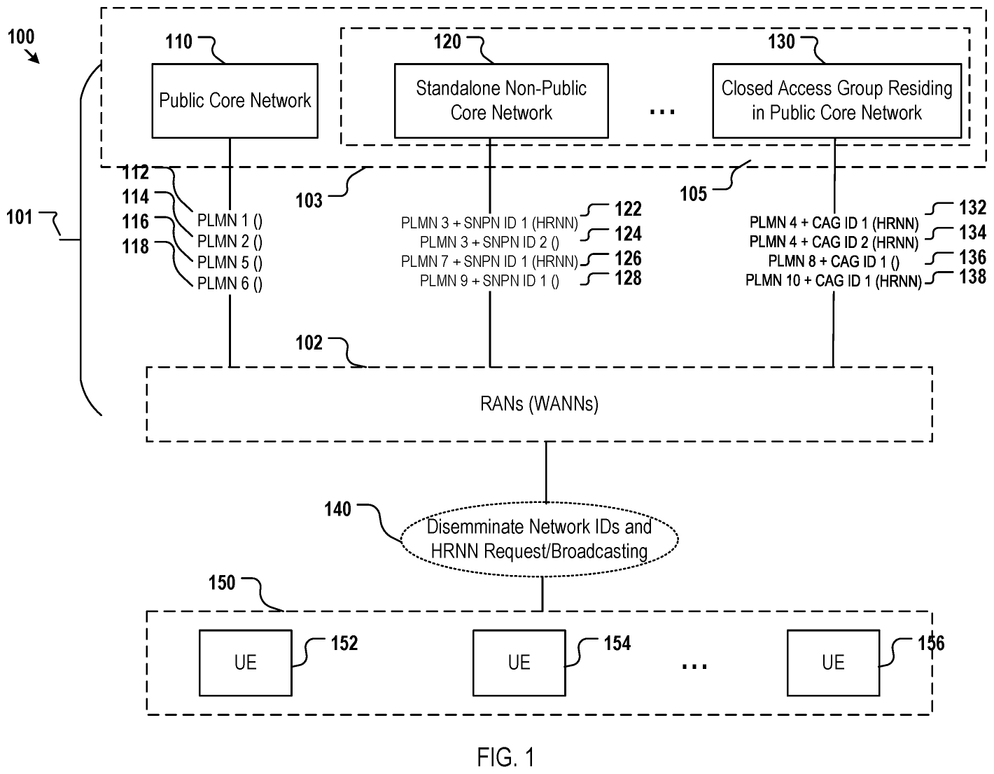

As shown in FIG. 1, wireless communication system 100 may include carrier portion of the network 101 and fixed or mobile wireless terminal devices 150 (alternatively referred to as user equipment (UE)). The carrier network 101 may include geographically distributed radio access networks (RANs) 102 for providing over-the-air (OTA) access to the fixed or mobile wireless terminal devices or UEs 150, such as UEs 152, 154, and 156 of FIG. 1. The carrier network 101 may further include core networks 103 for routing data traffic among radio access networks 102 or between radio access networks 102 and other data networks external to the core networks 103. The wireless access networks 102 may be connected to the core networks 103 via wired backhaul connections.

The OTA interfaces between the RANs 102 and the UEs 150 may be implemented using various wireless access technologies to cover a certain geographic region. For example, the RANs 102 may rely on cellular technologies to reuse radio resources. As such, the RANs may be implemented as various cells that collectively covers a service geographic region. Each cell may include one or more wireless access network nodes (WANN). Each of the UEs 150 may be registered, configured, and authenticated to access one or more of the WANNs.

The carrier network 101 may be provided by one or more service providers or network carriers. For example, a network carrier may provide both the RANs 102 and the core network 103 for an integrated wireless network access by the UEs 150. For another example, there may be multiple core networks, such as the core networks 110, 120, and 130 shown in FIG. 1. These different core networks may be provisioned and managed by independent network carriers. The RANs 102 including the WANNs may be provisioned by one or more of these network carriers of the core networks 103 or may be provided by some other independent wireless access network providers. A particular WANN may be connected to and shared by one or more core networks 103. In other words, the WANNs within the RANs 102 may be shared by different independent network carriers. Each WANN may maintain a list of core networks 103 it is connected to and configured to support. Different WANNs may support a same set or different sets of core networks 103. A maximum number of core networks that may be connected to a WANN may be predetermined. For example, a WANN may be connected to and provide service to at most 12 or other numbers of different core networks.

The core networks 103 may include both public and non-public core networks. For example, FIG. 1 shows a public land mobile networks (PLMNs) 110 and non-public core networks 105. The PLMNs 110 are typically built by major network carriers for routing data traffic over a large geographic region or regions and may constitute the main stream of core networks 103. A non-public core network may be alternatively referred to as a private core network. Different types of private core networks 105 may be provided in the wireless communication system 100. For example, the private core networks 105 may further include standalone non-public core networks (SNPNs) 120 and closed access groups (CAGs) 130. The SNPNs 120 may be built by a private entity (such as a corporation or an enterprise) and typically only provide local data traffic routing (e.g., within and between corporate sites). The CAGs 130, for example, may be implemented as private core networks within PLMNs for exclusively providing network access to a closed group of UEs. Because CAGs are usually implemented by leasing network resources in large PLMNs, they may provide large geographic coverage for the closed groups of mobile UEs, affording enhanced mobility within the CAG core networks.

Each of the public core networks 110 and private core networks 105 may be assigned and associated with a network identity. For example, each of the core networks 103, either public or private, may be associated with an overall network identification, referred to herein as a PLMN ID. In some implementations, public core networks 110 may be uniquely identified by their PLMN IDs whereas multiple private core networks may share a same PLMN ID. In other words, multiple private core networks 120 and 130 may be provided under a same PLMN ID. For example, a private core network provider may offer multiple independent SNPNs under a same PLMN ID. For another example, a private core network provider may lease network resources from a PLMN to provide services to multiple CAGs and these multiple different CAGs core networks may naturally assume the same PLMN ID as the underlying PLMN core network. These private core networks associated with the same PLMN IDs may be further identified by private network IDs attached or appended to their PLMN IDs. A private core network ID may be specified as either an SNPN ID or a CAG ID, depending on the nature of the private core network being either an SNPN or a CAG core network. In some implementations, private network IDs of the SNPN core networks may be reusable in different geographic areas since the SNPN core networks tend to be local, whereas private network IDs of the CAG core networks may be unique within large geographic regions due to their more global nature compared to the SNPN core networks. As such, the PLMN ID and private network ID combinations for the SNPN core networks may not be globally unique whereas the PLMN ID and private network ID combinations for the CAG core networks may tend to be globally unique.

FIG. 1 further illustrates an example network identity assignment scheme for various core networks 103. In FIG. 1, a particular WANN of the RANs 102 may be connected to and associated with a maximum number (e.g., 12) of core networks, including four PLMNs as shown by 112, 114, 116, and 118, four SNPN core networks as shown by 122, 124, 146, and 128, and four CAG core networks as shown by 132, 134, 136, and 138. These 12 core networks are assigned with 10 different PLMN IDs, including PLMN IDs 1, 2, 5, and 6 associated with the four PLMN core networks (as show by 112, 114, 116, and 118), PLMN IDs 3, 7, and 9 associated with the four SNPN core networks (as shown by 122, 124, 126, and 128), and PLMN IDs 4, 8, and 10 associated with the four CAG core networks (as shown by 132, 134, 136, and 138).

In the example of FIG. 1, the four PLMN core networks 110 are identified uniquely by their PLMN IDs (as shown by 112, 114, 116, and 118). As shown by 122, 124, 132, and 134, two different SNPNs share a same PLMN ID and two different CAGs share another PLMN ID. As further shown by 126, 128, 136, and 138 in the example of FIG. 1, two SNPNs and two CAGs do not share PLMN IDs with other SNPNs and CAGs. In some other implementations, a SNPN and a CAG may share a same PLMN ID (not shown in the example of FIG. 1). The list of these 12 core networks may be maintained by the particular WANN as its supported core networks. The WANN may maintain a single list of these core networks. The WANN may maintain separate lists of PLMN, SNPN, and CAG core networks. Alternatively, the WANN may maintain more than one list of each type of PLMN, SNP, and CAG core networks. Other manners in which the identities of the supported core networks are maintained may also be implemented.

The core networks 103 may be associated and configured with human readable network names (HRNNs). HRNNs may be particularly helpful for a user of a UE to recognize a private core network during manual selection of a servicing core network in the UE. HRNNs may be optional for the core networks 103. In other words, some core networks 103 may not be associated with any HRNNs. In some example implementations, none of the PLMN core networks 112-118 may be associated with any HRNN, as shown by the empty “( )” in 112-118. Further in the example of FIG. 1, the SNPN core networks 122 and 126 and the CAG core networks 132, 134 and 138 are associated with HRNNs, while the SNPN core networks 124 and 128, and the CAG core networks 136 are not associated with any HRNNs.

A WANN of a wireless cell may advertise or notify its supported list of core networks to UEs 150 within the service area of the wireless cell. As shown by 140 of FIG. 1, for example, the network IDs and/or HRNNs of the list of core networks supported by the WANN of the RAN 102 may be disseminated from the WANN to the UEs 150. The UEs 150 may be within service areas of multiple overlapping cells and thus may receive lists of supported core networks from multiple WANNs belongs to different cells. The UEs 150 may subsequently perform its cell and core network selections and obtain wireless network service either automatically or manually.

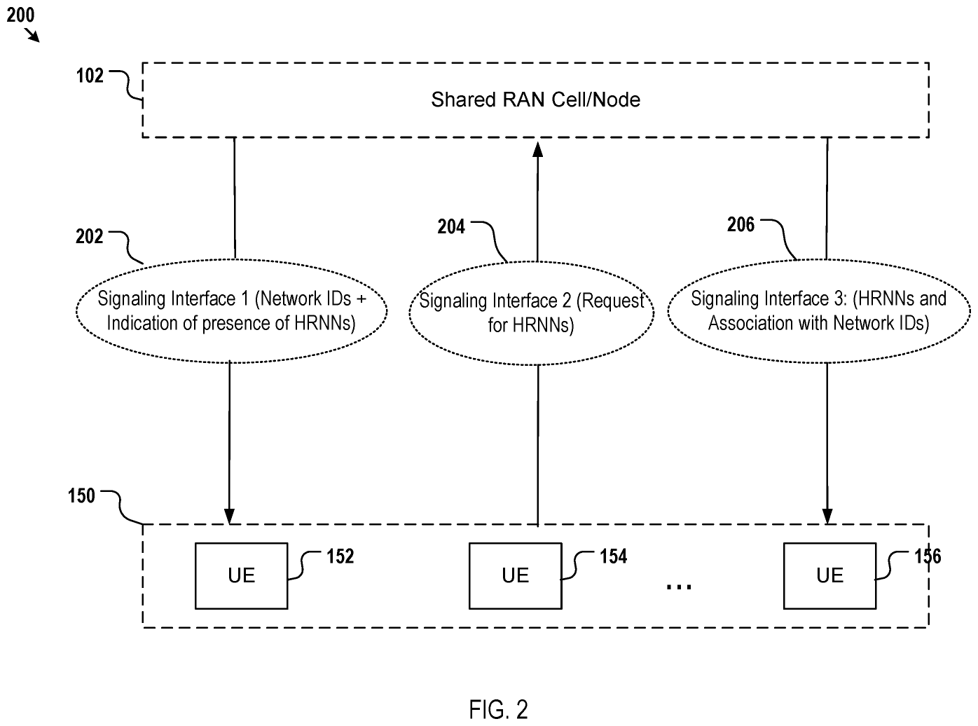

FIG. 2 shows an example implementation for a dissemination of network identity and HRNNs of core networks supported by a WANN of the RAN 102. Specifically, the core network information dissemination process may be implemented using messages transmitted via various wireless signaling interfaces between the RAN 102 and the UEs 150, as shown by 202, 204, and 206 of FIG. 2. These signaling interfaces may be involved in multiple distinct stages of the dissemination process. They may only need to be utilized by the UE 150 when necessary. For example, the network IDs discussed above for the core networks supported by the WANN may be broadcasted via wireless signaling interface 1 as shown in 202. Because the HRNN is optional and may not always be needed by the UEs 150 during their selection of servicing cells and core networks, it may be more efficient for the WANN to broadcast the network IDs of its supported core networks without simultaneously broadcasting the HRNNs of these core networks together with the network IDs. In order for the UEs 150 to determine whether an optional HRNN does exist for a particular core network by only reading the broadcasting message 202, separate indicator data fields may be included in the broadcast message 202 for indicating to the UEs 150 whether the HRNNs exist for the core networks and are obtainable from the WANN if needed.

In such a manner, the core network information dissemination from the WANN may be implemented in stages and as needed. In particular, a UE 150 may read and process the broadcast message 202 in a first stage and proceed into a second stage to further obtain one or more HRNNs only if they are needed by the UE and the corresponding HRNN indicator data fields signify that these HRNNs do exist. When an HRNN presence indicator data field signifies to the UE that no optional HRNN is present for the corresponding core network, the UE would not need to proceed further in an attempt to obtain non-existent information, thereby reducing the amount of data transmission and power consumption in the UE.

Continuing with FIG. 2, if the UE determines from the HRNN presence indicator fields of the broadcast message 202 that one or more HRNNs do exist and further decides to obtain the HRNNs from the WANN, the UE 150 may then proceed to the next stage by retrieving the HRNNs from the WANN 102 either by receiving/reading another spontaneous broadcast message from the WANN 102 as shown by 206, or on demand by first sending an HRNN request to the WANN which subsequently triggers the WANN to transmit (e.g., in broadcast mode or unicast mode) another message, as collectively shown by messages 204 and 206 of FIG. 2.

The messages 202 and 206, and the HRNN request 204 may be implemented via System Information Blocks (SIBs) or other signaling interfaces. Each of these messages may be transmitted using separate and independent SIBs or other signaling interfaces. In some exemplary implementations in 5G wireless networks, the messages 202 and 204 may be transmitted via the SIB1 and SIB10 interfaces, respectively. They may be alternatively transmitted via non-access stratum signaling interfaces or dedicated radio resource control (RRC) signaling interfaces. The HRNN request message 204, for another example, may be transmitted via a random channel access preamble interface, an RRC interface, or an uplink dedicated control channel (UL DCCH). Other signaling channels/interfaces or SIBs may be used for transmitting messages 202, 204, and 206.

The core network ID broadcast message 202, for example, may be included in the SIB1 and configured to specify the lists of core networks supported by the WANN and other system information. The core network lists and the other system information may be specified in the manner illustrated by the example SIB1 message configuration scheme shown below (labeled as Configuration 1):

Configuration 1

```
  CellAccessRelatedInfo ::= SEQUENCE {
      plmn-IdentityList PLMN-IdentityInfoList,
            cellReservedForOtherUse ENUMERATED {true} OPTIONAL,
  -- Need R
            privateNetwork-InfoList PrivateNetwork-InfoList optional
            ...
  }
  PrivateNetwork-InfoList ::= SEQUENCE (SIZE (1..maxPLMN)) OF
  PrivateNetwork-Info
  PrivateNetwork-Info ::= SEQUENCE {
    cellInfo CHOICE{
                cellInformaiton CellInformation,
                plmn-Index INTEGER (1..maxPLMN) },-- Set to the plmn index
  in the plmn-IdentityList with the same cellInformation(TAC/ranac/cellIdentitiy....)
              snpn-InfoList SEQUENCE (SIZE (1..maxSNPN)) OF SNPN-
  Info, -- Cond SNPN
              cag-InfoList SEQUENCE (SIZE (1..maxCAG)) OF CAG-Info --
  Cond CAG
        ...
  }
    CellInformation::= SEQUENCE{
        trackingAreaCode TrackingAreaCode OPTIONAL, -- Need
  R
      ranac RAN-AreaCode OPTIONAL, -- Need R
      cellIdentity CellIdentity,
            cellReservedForOperatorUse ENUMERATED {reserved, notReserved}
            ...
  }
snpn-IdentityInfoList SEQUENCE (SIZE (1..maxNPN)) OF SNPN-IdentityInfo, --
Cond SNPN
SNPN-IdentityInfo ::= SEQUENCE{
          plmn-Identity PLMN-Identity,
          snpn-IDInfoList SEQUENCE (SIZE (1..maxNPN))OF SNPNInfo,
  }
SNPNInfo ::= SEQUENCE {
          snpn-ID SNPN-ID,
          redableNamePresent ENUMERATED {TRUE} OPTIONAL, -- Need R
          s-NSSAI-List SEQUENCE (SIZE (1..maxNrofS-NSSAI)) OF S-NSSAI
OPTIONAL
          ims-EmergencySupport-SNPN ENUMERATED {TRUE} OPTIONAL,
Need R
          eCallOverIMS-Support-SNPN ENUMERATED {TRUE} OPTIONAL,
Need R
  }
cag-IdentityInfoList SEQUENCE (SIZE (1..maxNPN)) OF CAG-IdentityInfo, --
Cond CAG
CAG-IdentityInfo ::= SEQUENCE {
          plmn-Identity PLMN-Identity,
          cag-IDInfoList SEQUENCE (SIZE (1..maxNPN))OF CAGInfo,
  }
CAGInfo ::= SEQUENCE {
          cag-ID CAG-ID,
          redableNamePresent ENUMERATED {TRUE} OPTIONAL, -- Need R
          s-NSSAI-List SEQUENCE (SIZE (1..maxNrofS-NSSAI)) OF S-NSSAI
OPTIONAL
          ims-EmergencySupport-SNPN ENUMERATED {TRU} OPTIONAL, --
Need R
          eCallOverIMS-Support-SNPN ENUMERATED {TRUE} OPTIONAL, --
Need R
  }
```

The SIB1 message configuration scheme above illustrates how the lists of SNPN core networks and CAG core networks may be specified in the message 202. For simplicity, the core network list above does not include lists of PLMN core networks which typically are not associated with any HRNNs. The example configuration scheme above thus specifies one or more lists (the sequence of “SNPN-Identity Info” above) of SNPN core networks with each list having a common PLMN ID. Each list of SNPN core networks having a common PLMN ID is specified by the sequence of “snpn-IDInfoList”. In an SNPN list, the SNPN IDs of the SNPN core networks are specified. In addition, HRNN presence indicators for the SNPN core networks in the SNPN list (“redableNamePresent” data field in the sequence of “SNPNInfo”, as highlighted in bold font above) are included to indicate whether the HRNNs corresponding to the SNPN IDs are present and can be obtained in a separate system information message 206 from the WANN.

Likewise, the example SIB1 message configuration scheme above also specifies one or more lists (the sequence of “CAG-Identity Info” above) of CAG core networks with each list having a common PLMN ID. Each list of CAG core networks having a common PLMN ID is specified by the sequence of “cag-IDInfoList” above. In a CAG list, the CAG-IDs of the CAG core networks are specified. In addition, HRNN presence indicators for the CAG core networks in the CAG list (“redableNamePresent” data field in the sequence of “CAGInfo” above) are included to indicate whether the HRNNs corresponding to the CAG-IDs are present and can be obtained in a separate system information message 206 from the WANN.

Other highlighted data fields (the bold-font data fields other than the “readableNamePresent” data field) in the example SIB1 Configuration 1 above further specify several other optional service capabilities of the SNPN and CAG core networks listed in the message 202 of FIG. 2. Specifically, an SNPN or CAG core network may optionally support network slicing. As such, a list of single network slicing selection assistance information (s-NSSAI) for supported network slices for the SNPN or CAG core network (the sequence of “s-NSSAI-List”) may be specified. Additionally, an SNPN or CAG core network may optionally support a Voice/IMS emergency service. As such, a data field, e.g., “IMS-EmergencySupport-SNPN” and a data field, e.g., “IMS-EmergencySupport-CAG” respectively for an SNPN and a CAG core network may be included in the message 202 to indicate whether such an emergency service is supported. Further, an SNPN or CAG core network may also optionally support an eCallOverIMS service. As such, a data field, e.g., “eCallOverIMS-Support-SNPN” and a data field, e.g., “eCallOverIMS-Support-CAG” may be respectively included for an SNPN and a CAG core network in the message 202 to indicate whether such an eCall service is supported.

The implementation shown in the example SIB1 message configuration scheme above (Configuration 1) specifies the availability of the voice/IMS emergency service and the eCallOverIMS service for each SNPN or CAG core network individually. In some other implementations, one voice/IMS emergency availability data field and/or one eCallOverIMS availability data field may be specified for all SNPN core networks. Likewise, one voice/IMS emergency availability data field and/or one eCallOverIMS availability data field may be specified for all CAG core networks. Portions of an example SIB1 message configuration specifying availability of these services are shown below (labeled as “Configuration 2” and “Configuration 3”):

Configuration 2

-- ASN1START
-- TAG-SIB1-START
SIB1 ::= SEQUENCE {
...
IMS-EmergencySupport-SNPN ENUMERATED {true} OPTIONAL, -- Need R
IMS-EmergencySupport-CAG ENUMERATED {true} OPTIONAL, -- Need R
....
}
-- TAG-SIB1-STOP
-- ASN1STOP

Configuration 3

-- ASN1START
-- TAG-SIB1-START
SIB1 ::= SEQUENCE {
...
eCallOverIMS-Support-SNPN ENUMERATED {true} OPTIONAL, -- Need R
eCallOverIMS-Support-CAG ENUMERATED {true} OPTIONAL, -- Need R
....
}
-- TAG-SIB1-STOP
-- ASN1STOP

Based on the Configuration 2 and Configuration 3, if the UE operates in the SNPN mode, the UE shall ignore the “cellreservedforotheruse” data field shown in Configuration 1 and decide whether the network support Voice/IMS-Emergency or eCallOverIMS based on the IMS-EmergencySupport-SNPN or the eCallOverIMS-Support-SNPN data fields above.

If the UE does not operate in the SNPN mode and is instead configured with an allowed CAG list, the UE shall check “cellreservedforotheruse” data field shown in Configuration 1 first to decide whether this cell is reserved for SNPN. If the cell is reserved for SNPN, the UE may not further check the IMS-EmergencySupport-CAG or the eCallOverIMS-Support-CAG to decide whether the network support IMS-Emergency/eCallOverIMS through the CAG cell.

The Configuration 1 above further include other system information related to the WANN, such as the whether the cell is reserved for various uses (including uses for SNPN, data field “cellReservedForOtherUse”) and other cell information, which are self-explanatory in the Configuration 1.

The core networks in the SNPN lists and CAG lists shown in the SIB1 message scheme of Configuration 1 above and the PLMN core network lists (not shown above for simplicity) may be ordered and indexed according to some predefined ordering and indexing rules. These ordering and indexing rules may be specified by a protocol. Table 1 below shows an example core network index allocation (0 to 11) for the 12 core networks connected to and sharing the WANN in FIG. 1. As an example, Table 1 shows two PLMN core network lists (PLMN list 1 and PLMN list 2), three SNPN lists (SNPN list 1, 2 and 3), and three CAG lists (CAG list 1, 2, and 3). The various core network IDs would be specified in the example SIB1 message Configuration 1 above. Further, whether an HRNN is present and obtainable for each of the core networks in Table 1 would also be specified by the corresponding HRNN presence indicator data field specified in the example SIB1 message Configuration 1 above. The indexes 0-11 in Table 1 rather than the actual network IDs may be used for the UEs and WANN to represent and identify corresponding core networks.

TABLE 1

| Index | Network Identifier |
|---|---|
| 0 | PLMN 1 of legacy Plmn list 1 |
| 1 | PLMN 2 of legacy PLMN list 1 |
| 2 | PLMN 5 of legacy PLMN list 2 |
| 3 | PLMN 6 of legacy PLMN list 2 |
| 4 | PLMN 3 + SNPN ID 1 of SNPN ID list 1 |
| 5 | PLMN 3 + SNPN ID 2 of SNPN ID list 1 |
| 6 | PLMN 7 + SNPN ID 1 of SNPN ID list 2 |
| 7 | PLMN 9 + SNPN ID 1 of SNPN ID list 3 |
| 8 | PLMN 4 + CAG ID 1 of CAG ID list 1 |
| 9 | PLMN 4 + CAG ID 2 of CAG ID list 1 |
| 10 | PLMN 8 + CAG ID 1 of CAG ID list 2 |
| 11 | PLMN 10 + CAG ID 1 of CAG ID list 3 |

Turning to the message 206 of FIG. 2, the WANN may spontaneously broadcast HRNNs and their association with SNPN and CAG core networks. Alternatively, the WANN may broadcast or unicast the message 206 on demand from UEs. The message 206 may be transmitted using various signaling interfaces discussed above. For example, the message 206 may be included, for example, in SIB10 message from the WANN. The HRNNs may be listed in the message 206. The association of the listed HRNNs with SNPN and CAG core networks may be implemented in various manners. In one example implementation, the message 206 may include an HRNN list with each HRNN paired with its corresponding network ID or network index as specified, for example, in Table 1 above. An example of such an implementation using the network indexes is shown in an SIB10 message configuration scheme below (labeled as “Configuration 4”) with the HRNN and network index pair data fields highlighted in bold-font.

Configuration 4

```
-- ASN1START
-- TAG-SIB10-START
SIB10 ::= SEQUENCE {
    readableNameList SEQUENCE (SIZE (1..maxSNPN))OF ReadableName,
OPTIONAL, -- Need R
  lateNonCriticalExtension OCTET STRING OPTIONAL,
  ...
}
ReadableName::= SEQUENCE {
    readableName-index INTEGER (1..maxNPN),
    readableName OCTET STRING
}
-- TAG-SIB10-STOP
-- ASN1STOP
```

A further illustrative example following Configuration 4 with specific set of HRNNs and network indexes is shown below in Configuration 5. As shown in Configuration 5, HRNNs of core networks with network indexes of “4” and “8” (out of indexes 0-11, for example, and as illustrate in bold-font in Configuration 5) are specified. The network IDs for these core networks are determined by these network indexes according to, for example, the association between the network indexes and the network IDs in Table 1.

Configuration 5

```
SIB10 ::= SEQUENCE {
    readableNameList SEQUENCE (12) OF ReadableName, OPTIONAL, --
Need R
  lateNonCriticalExtension OCTET STRING OPTIONAL,
  ...
}
ReadableName [0]=
```

| | |
|---|---|
| readableName-index | 4, |
| readableName | OCTET STRING |

ReadableName [1]=

| | |
|---|---|
| readableName-index | 8, |
| readableName | OCTET STRING |

}

Alternatively, the message 206 may specify association of the listed HRNNs with SNPN and CAG core networks with positional information of the HRNN list embedded in the message 206. An example of such an implementation is shown in an SIB10 message configuration scheme below (labeled as “Configuration 6”). Specifically, the highlighted “redableName” sequence below is a sequence of components each corresponding to one of the network indexes in, for example, Table 1. For the core networks that do not have any HRNN, the corresponding components in the “redableName” sequence would be specified as being empty. Otherwise, a HRNN would be listed.

Configuration 6

```
-- ASN1START
-- TAG-SIB10-START
SIB10 ::= SEQUENCE {
    readableNameList SEQUENCE (SIZE (1..maxNPN))OF ReadableName
OPTIONAL, -- Need R
  lateNonCriticalExtension OCTET STRING OPTIONAL,
  }
ReadableName::= SEQUENCE{
    readableName OCTET STRING OPTIONAL
}
-- TAG-SIB10-STOP
-- ASN1STOP
```

A further example following Configuration 6 with a specific set of HRNNs is illustrated below in Configuration 7. As shown in Configuration 7, specific HRNNs of core networks with network index of “4” and “8” (out of indexes 0-11, for example, and as illustrate in bold-font) are specified. Core networks with indexes 0-3, 5-7, and 9-11 are not associated with any HRNNS and these corresponding components in the “ReadableName” sequence do not specify any HRNNs. Again, the network IDs for the core networks listed in the Configuration 7 are determined by their positions in the sequence as indexes into Table 1.

Configuration 7

SIB10 ::= SEQUENCE {

| | |
|---|---|
| readableNameList | SEQUENCE (12) OF ReadableName, OPTIONAL, -- |

Need R

| | |
|---|---|
| lateNonCriticalExtension | OCTET STRING OPTIONAL, |

}
ReadableName [0~3]= {readable name not present}
ReadableName [4]=

| | |
|---|---|
| readableName | OCTET STRING |

ReadableName [5~7]= {readable name not present}
ReadableName [8]=

| | |
|---|---|
| readableName | OCTET STRING |

ReadableName [9~11]= {readable name not present}
}

In some implementations, the message 206 of FIG. 2 may include the list of HRNNs and may further indicate their association with the core networks using a bit map. An example of such an implementation is shown in an SIB10 message configuration scheme below (labeled as “Configuration 8”). Specifically, as highlighted below, a bit map “presenceOfHRNN” may be included in the message 206 to indicate which core networks are associated with HRNNs that are listed in the “HumanReadableName” sequence. Each bit in the bit map constitute an indicator field corresponding to one core networks.

Configuration 8

-- ASN1START
-- TAG-SIB10-START
SIB10 ::= SEQUENCE {

| | |
|---|---|
| presenceOfHRNN | BIT STRING (SIZE (maxNPN)) OPTIONAL, -- Need |

R
humanReadableNameList HumanReadableNameList OPTIONAL, -- Need R

| | |
|---|---|
| lateNonCriticalExtension | OCTET STRING OPTIONAL, |

...
}

| | |
|---|---|
| HumanReadableNameList::= | SEQUENCE (SIZE (1..maxNPN)) OF |

HumanReadableName

| | |
|---|---|
| HumanReadableName ::= | SEQUENCE{ |
| humanReadableName | OCTET STRING |

}
-- TAG-SIB10-STOP
-- ASN1STOP

The ordering of the individual bits in the bit map above may be implemented in various exemplary manners. In some implementations, the bit map “presenceOfHRNN” may be ordered in correspondence to the SNPN and CAG core network lists. For the core networks in Table 1, for example, there are four SNPN core networks and four CAG core networks, and as such, the first four bits of the bit map “presenceOfHRNN” may be used to indicate presence of HRNNs for the four SNPN core networks in the “humanReadableName” sequence above (e.g., with “1” indicating an association, and “0” indicating no association). The next four bits in the bit map “pressenceOfHRNN” may be used to indicate presence of HRNNs for the four CAG core networks in the “humanReadableName” sequence. The bit map “presenceOfHRNN” may be set at a length determined by the maximum number of core networks that may be supported by the WANN (e.g., 12). The rest of the 12 bits may be used to indicate presence of HRNNs for PLMN core networks in the “humanReadableName” sequence (if some PLMN core networks are associated with HRNNs). Unused bits in the bit map may be zero padded. For the example of Table 1, a bit map “presenceOfHRNN” of “110000110000” would indicate that the first and second SNPN core networks (indexes 4 and 5 in Table 1) out of the four SNPN core networks, and the third and fourth CAG core networks (indexes 10 and 11 in Table 1) out of the four CAG core networks are associated with HRNNs. Correspondingly, four HRNNS may be listed in the “humanReadableName” sequence above and corresponding to core networks with indexes in the order of index 4, 5, 10, and 11 in Table 1.

In some alternative implementations to the Configuration 8 above, multiple bit maps rather than a single bit map may be included in the SIB10 message for indicating association between core networks and HRNNs. The HRNNs may be specified in either a single sequence or in multiple sequence corresponding to the multiple bit maps. An example of such an implementation is shown in an SIB10 message configuration scheme below (labeled as “Configuration 9”). In Configuration 9, separate HRNN presence bit maps are specified for the SNPN core networks and CAG core networks, as highlighted below. A single sequence of HRNNs are specified in the example of Configuration 9.

Configuration 9

```
-- ASN1START
-- TAG-SIB10-START
SIB10 ::= SEQUENCE {
    humanReadableNameForSNPN HumanReadableNameForSNPN OPTIONAL,
-- Need R
    humanReadableNameForCAG HumanReadableNameForCAG OPTIONAL, -
- Need R
    lateNonCriticalExtension OCTET STRING OPTIONAL,
    ...
}
HumanReadableNameForSNPN ::= SEQUENCE {
presenceOfHRNN BIT STRING (SIZE (maxNPN)) OPTIONAL, -- Need R
humanReadableNameList HumanReadableNameList OPTIONAL, -- Need R
...
}
HumanReadableNameForCAG ::= SEQUENCE {
  presenceOfHRNN BIT STRING (SIZE (maxNPN)) OPTIONAL, -- Need R
  humanReadableNameList HumanReadableNameList OPTIONAL, -- Need R
  ...
}
HumanReadableNameList ::= SEQUENCE (SIZE (1..maxNPN)) OF
HumanReadableName
HumanReadableName ::= SEQUENCE {
  humanReadableName OCTET STRING
}
-- TAG-SIB10-STOP
-- ASN1STOP
```

The ordering of the individual bits in the multiple bit maps in the Configuration 9 above may be implemented in various exemplary manners. In some implementations, the bit maps “presenceOfHRNN” for the SNPN core networks and the CAG core networks may be ordered in correspondence to the SNPN and CAG core network lists, respectively. The bit maps may each be set at a bit-length determined by the maximum number of core networks that may be supported by the WANN (e.g., 12). For the core networks in Table 1, for example, there are four SNPN core networks and four CAG core networks. The first four bits of the “presenceOfHRNN” bit map for the SNPN core networks may be used to indicate whether the four SNPN core networks are associated with any HRNNs (e.g., with “1” indicating an association, and “0” indicating no association). The rest of the 8 bits in this bit map may be zero padded. Likewise, the first four bits of the bit map “presenceOfHRNN” for the CAG core networks may be used to indicate presence of HRNNs for the four SNPN core networks and the rest of the 8 bits in this bit map may be zero padded. For the example of Table 1, a bit map “presenceOfHRNN” of “101000000000” for the SNPN core networks would indicate that the first and third SNPN core networks (indexes 4 and 6 in Table 1) are associated with HRNNs. Likewise, a bit map “presenceOfHRNN” of “011100000000” for the CAG core networks would indicate that the second, third, and fourth CAG core networks (indexes 9, 10, and 11 in Table 1) are associated with HRNNs. Correspondingly, five HRNNS may be listed in the single “humanReadableName” sequence of the Configuration 9 above and corresponding to core networks indexes in the order of index 4, 6, 9, 10, and 11 in Table 1.

While the message 206 containing the list or lists of HRNNs with or without the bit maps in the example configurations above are illustrated as being sent via SIB10 interface, it may be alternatively transmitted using other signaling interfaces including but not limited to other SIBs, non-access stratum (NAS) signaling interface, or radio resource control (RRC) signaling interface, other broadcasting/unicasting signaling interfaces, and signal interfaces for providing on demand system information.

The list of HRNNs may be acquired by a UE either following spontaneous broadcasting of the message 206 by the WANN or by triggered broadcasting/unicasting of message 206 as prompted by an HRNN request message 204 from the UE, as discussed above in connection with FIG. 2. In the situation where the message 206 is triggered by the HRNN request 204 from the UE, the message 206 may only need to contain one or more HRNNs for core networks being requested in the HRNN request message 204 rather than a full HRNN list.

For example, in the HRNN request message 204, the UE may send a requesting bit map for indicating the core networks for which HRNNs are requested. The requesting bit map may be formulated in a similar manner as the HRNN presence bit maps described above in relation to Configurations 8 and 9, except that the bits within the requesting bit map are used to indicate whether HRNNs are inquired by the UE for the corresponding core networks. Upon receiving the request, the WANN may extract the requesting bit map and determining the set of one or more core networks for which HRNNs are requested, and then retrieve the HRNN information to compose the message 206 with requested HRNN information. The message 206 in this case may be transmitted as SIB10 message following the SIB10 configurations discussed above or may be transmitted using other alternative configurations and signaling interfaces.

The HRNN request message 204 may be transmitted via an SIB interface, a random channel access preamble interface, an RRC interface, an uplink dedicated control channel (UL DCCH), or other system information signaling interface. An example configuration of the HRNN request message 204 as a RRC system information request message is shown below (labeled as Configuration 10). In the example of Configuration 10, the HRNN request bit map is used to identify the core networks for which the HRNNs are requested.

Configuration 10

```
-- ASN1START
-- TAG-RRCSYSTEMINFOREQUEST-START
RRCSystemInfoRequest ::= SEQUENCE {
  criticalExtensions CHOICE {
    rrcSystemInfoRequest-r15 RRCSystemInfoRequest-r15-IEs,
    criticalExtensionsFuture SEQUENCE { }
  }
}
RRCSystemInfoRequest-r15-IEs ::= SEQUENCE {
  requested-SI-List BIT STRING (SIZE (maxSI-Message)), --32bits
  Requested-HRNN-Bitmap BIT STRING (SIZE (12)) OPTIONA-- Need R
}
-- TAG-RRCSYSTEMINFOREQUEST-STOP
-- ASN1STOP
```

HRNN requests 204 may be sent by multiple UEs to the WANN and each UE may request HRNNs for a different sets of one or more core networks. In some implementations, the WANN may broadcast a message 206 each time a request 204 is made, but may compose the HRNN lists in the messages 206 in an accumulative manner, as illustrated in the example messaging flow below:

(1) Step 1: UE 1 sends a first request message with a first Requested-HRNN-bitmap which only indicates core network with, e.g., index 4 in Table 1.

(2) Step 2: The WANN sends a first SIB10 message providing an HRNN only for core network with index 4 according to Table 1:

```
SIB10::= SEQUENCE {
    readableNameList SEQUENCE (1) OF ReadableName, OPTIONAL, --
Need R
  lateNonCriticalExtension OCTET STRING OPTIONAL,
...
  }
ReadableName [0]=
  readableName-index 4,
  readableName OCTET STRING
}
```

(3) Step 3: UE 2 sends a second request message with a second Requested-HRNN-bitmap which only indicate core network with, e.g., index 8 in Table 1.

(4) Step 4: The WANN sends a second SIB10 message with the HRNNs of core networks correspond to both index 4 and index 8:

SIB10::= SEQUENCE}

| | |
|---|---|
| readableNameList | SEQUENCE (2) OF ReadableName, OPTIONAL, -- |

Need R

| | |
|---|---|
| lateNonCriticalExtension | OCTET STRING OPTIONAL, |

...
}
ReadableName [0]=

| | |
|---|---|
| readableName-index | 4, |
| readableName | OCTET STRING |

ReadableName [1]=

| | |
|---|---|
| readableName-index | 8, |
| readableName | OCTET STRING |

}

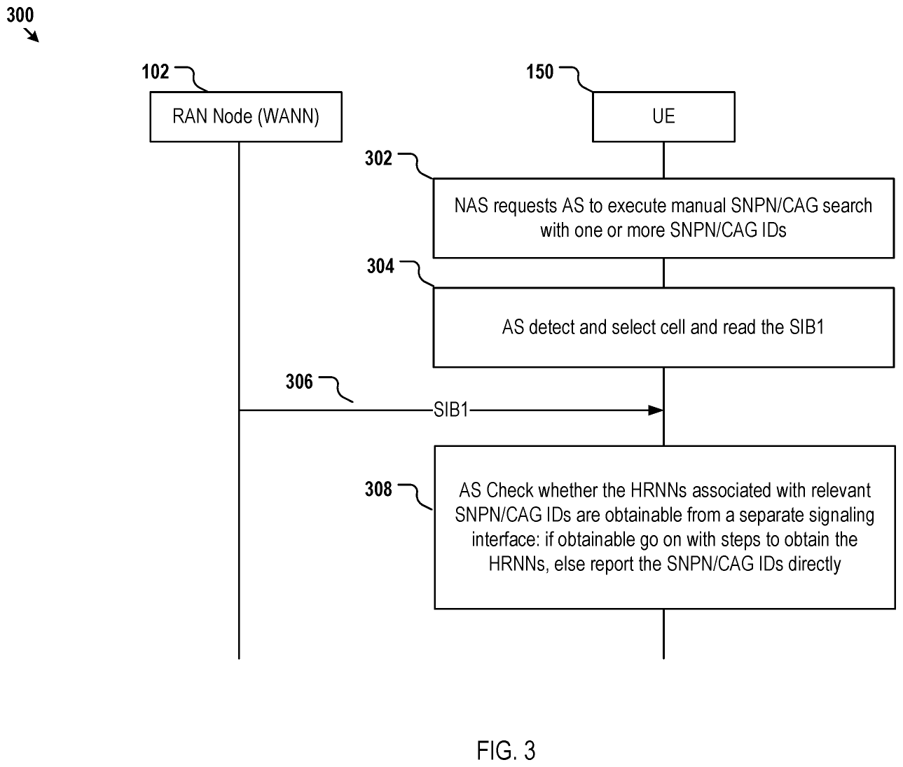

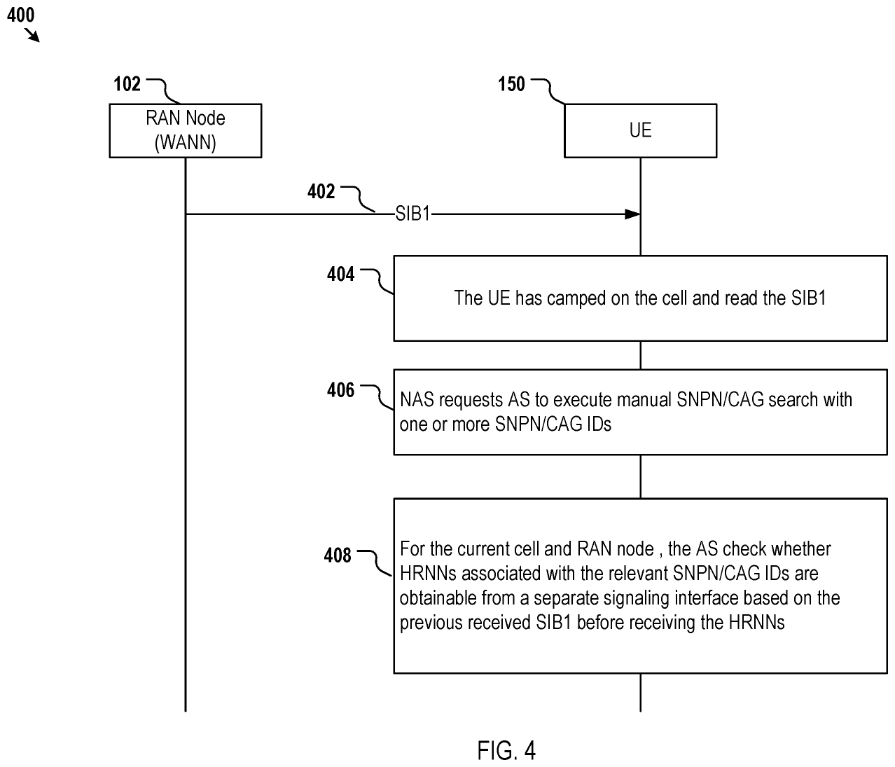

Moving on to operations in the UE side for obtaining HRNN information, FIGS. 3-8 show various data and logic flow that may be implemented for the UE. In particular, the UE 150 in FIG. 3-4 may include a non-access stratum (NAS) layer for establishment of communication sessions and for maintaining continuous communication for the UE while it moves, and access stratum (AS) layer responsible for carrying information over the wireless network. These layers may be configured to perform various different roles in the selection of a servicing private core networks for the UE, as shown in FIGS. 3-8 and in the summary below with respect to Table 2 following the description of FIGS. 3-8. A manual selection of servicing core network among one or more core networks that are available to provide service may be performed when the UE 150 capable of supporting an SNPN mode and/or registered within a CAG is in an RRC idle or an RRC inactive state and may desire to identify and obtain service from a SNPN or CAG core network.

FIG. 3 shows an example logic and data flow 300 for manual selection of private core network in a mobile terminal device relying on HRNNs. In 302, the NAS layer requests the AS layer of the UE 150 to execute manual SNPN/CAG search according to a list of SNPN/CAD IDs that the UE 150 may have access to. In 304, the AS layer proceed to perform cell detection for receiving, for example, an SIB1 message from the RAN node (or WANN) 102. In 306, the SIB1 message is broadcasted by the WANN 102 and received by the AS layer of the UE 150. In 308, the AS layer of the UE 150 checks the HRNN presence indicator fields in the received SIB1 message to determine whether the HRNNs associated with relevant SNPN/CAG IDs are existent and are obtainable from a separate signaling interface. If the relevant HRNNs are in existence, the UE may further proceed to retrieve the HRNNs from the WANN 102 and otherwise, would rely on the SNPN/CAG IDs contained in the SIB1 message 308 for manual core network selection.

FIG. 4 shows another example logic and data flow 400 where the UE 150 may have already camped on a particular cell and have already read the SIB1 broadcast message containing the HRNN list, as shown by 402 and 404. As shown in 406, the NAS layer of the UE 150 may request the AS layer to perform manual SNPN/CAG search according to a list of SNPN/CAD IDs that the UE 150 may have access to. In 408, the AS layer may check whether the currently cell the UE has already camped on provides needed HRNN information by checking the SIB1 message 402 already received previously.

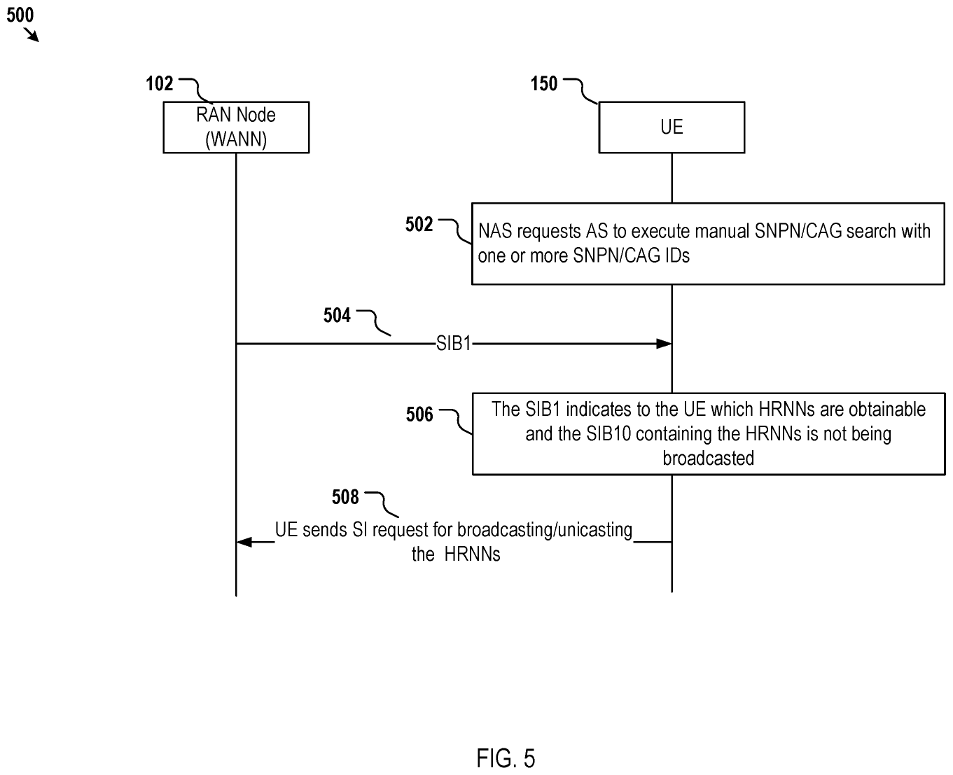

FIG. 5 shows an example logic and data flow 500 or manual selection of private core network in UE 150 where the HRNN information is requested by the UE 150 from the WANN 102. In 502, the NAS layer requests the AS layer of the UE 150 to execute manual SNPN/CAG search according to a list of SNPN/CAD IDs that the UE 150 may have access to. The AS layer proceed to perform cell detection for receiving, for example, an SIB1 message 504 from the RAN node (or WANN) 102. In 506, the AS layer of the UE 150 checks the HRNN presence indicator fields in the received SIB1 message to determine SNPN or CAG core networks for which HRNNs are existent and obtainable. In this implementation, the HRNNs may not be spontaneously broadcasted by the WANN 102. As such, the UE 150 may send system information request 508 to the WANN 102 for the WAN 102 to broadcast or unicast the HRNN information, in exemplary manners as discussed above for message 204 of FIG. 2.

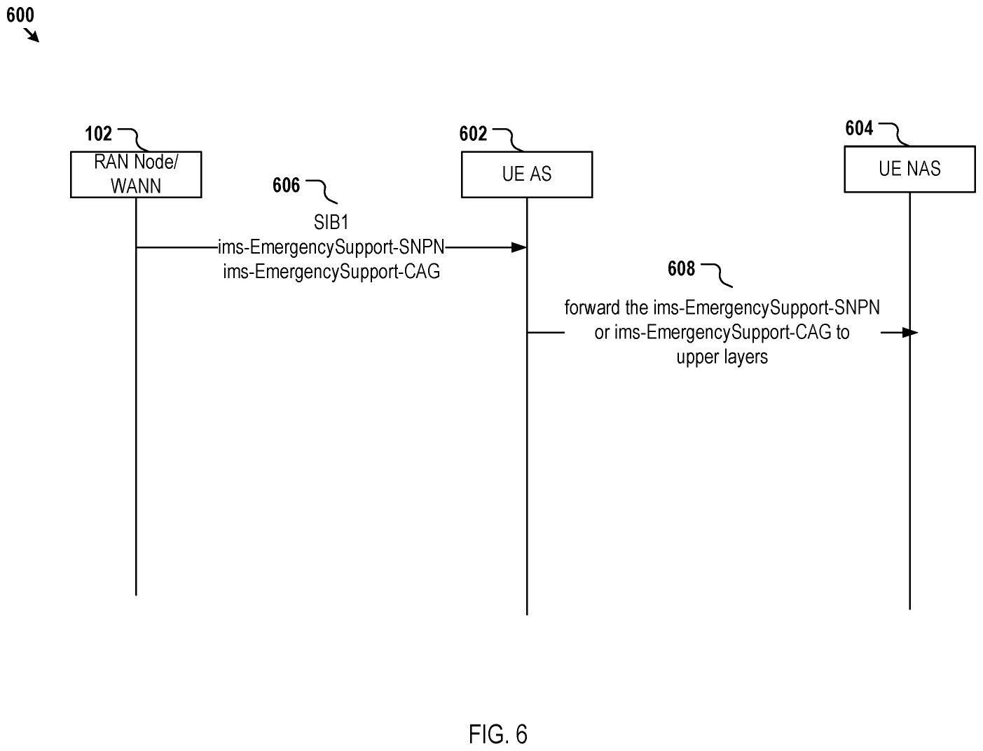

FIG. 6 shows an example logic and data flow 600 for handling voice or IMS emergency service availability in SNPN or CAD core networks by the NAS layer 604 and AS layer 602 of the UE. In 606, The AS layer 602 may receive an SIB1 broadcast message from WANN 102, which, in addition to including SNPN and/or CAG core network IDS and HRNN presence indicators, may further include indicator fields for indicating whether voice/IMS emergency service is available in these SNPN or CAG core networks. In 608, the AS layer 602 of the UE may further forward the voice/IMS emergency service availability information and the corresponding SNPN and CAG core network information to the NAS layer 604 and other upper layers of the UE for processing.

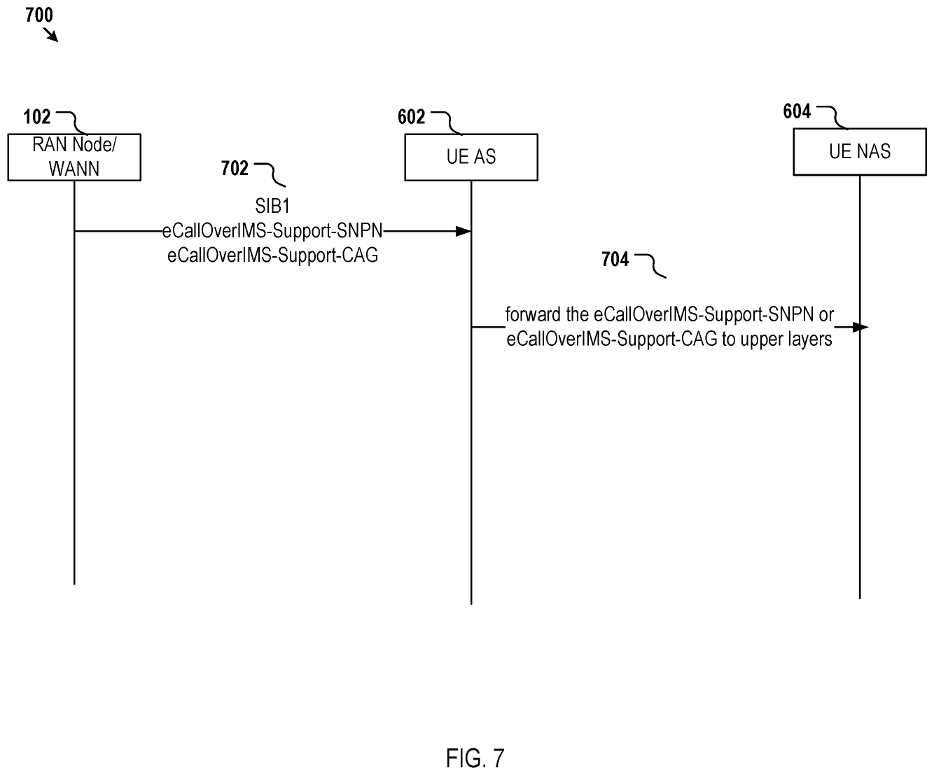

FIG. 7 shows an example logic and data flow 700 for handling eCall over IMS service availability in SNPN or CAD core networks by the NAS layer 604 and AS layer 602 of the UE. In 702, The AS layer 602 may receive an SIB1 broadcast message from WANN 102, which, in addition to including SNPN and/or CAG core network IDS and HRNN presence indicators, may further include indicator fields for indicating whether eCall over IMS service is available in these SNPN or CAG core networks. In 704, the AS layer 602 of the UE may further forward the eCall over IMS service availability information and the corresponding SNPN and CAG core network information to the NAS layer 604 and other upper layers of the UE for processing.

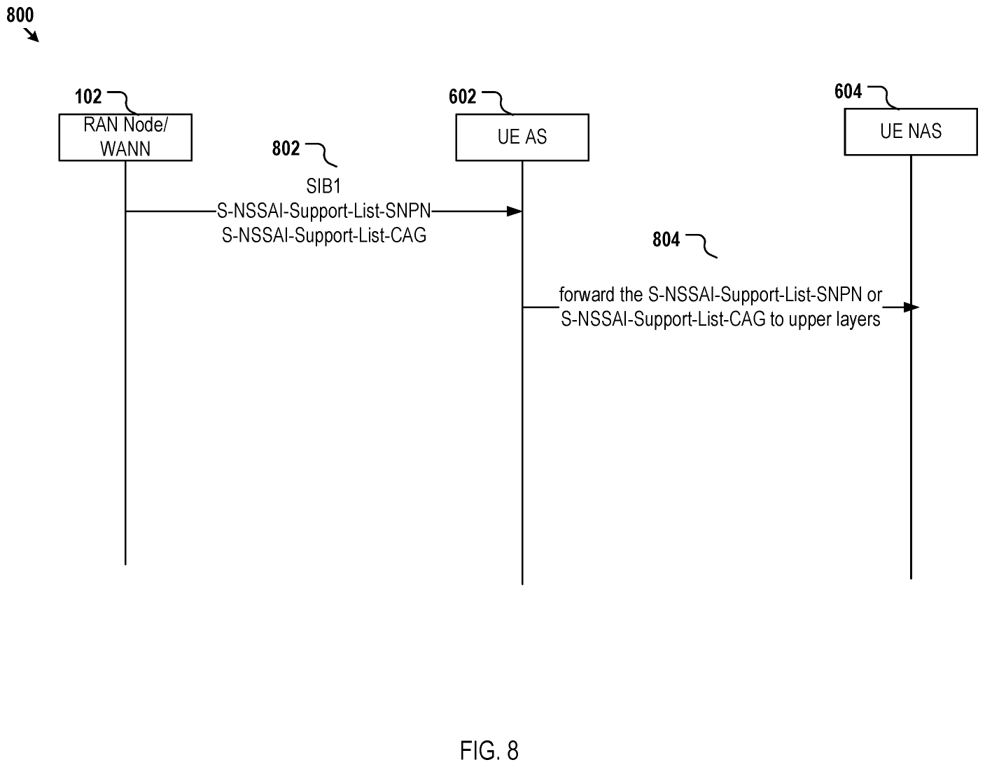

FIG. 8 shows an example logic and data flow 800 for handling network work slicing service in SNPN or CAD core networks by the NAS layer 604 and AS layer 602 of the UE. In 802, The AS layer 602 may receive an SIB1 broadcast message from WANN 102, which, in addition to including SNPN and/or CAG core network IDS and HRNN presence indicators, may further include data fields indicating various network slides supported by the SNPN or CAG core networks. In 804, the AS layer 602 of the UE may further forward information about the network slides supported by the SNPN or CAG core networks to the NAS layer 604 and other upper layers of the UE for processing.

Table 2 below further summarizes and includes additional information with respect to the functionality of the NAS and AS layers of the UE 150 in the manual selection of SNPN/CAG core network selection.

TABLE 2

| RRC_IDLE and | | |
|---|---|---|
| RRC_INACTIVE | | |
| state Process | UE Non-Access Stratum | UE Access Stratum |
| Support for manual | Provide request to search for | Search for cells with a |
| CAG/SNPN | available CAG/SNPN s. | CAG/SNPN ID. |
| selection | Evaluate reports of available | Read the HRNN of the |
| | CAG/SNPNs from AS for | CAG/SNPN from broadcast or |
| | CAG/SNPN selection. | unicast signal interfaces, e.g., |
| | Select a CAG/SNPN and request | SIB10 if a cell with a |
| | AS to select a cell belonging to this | CAG/SNPN ID is found. |
| | CAG/SNPN. | Report CAG/SNPN ID of the |
| | | found cell broadcasting a |
| | | CAG/SNPN ID together with |
| | | the HRNN and PLMN(s) to |
| | | NAS. |

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed in a wireless access network node, comprising:
generating a core-network availability system information message comprising:
a first network identifier corresponding to a first core network that connects to the wireless access network node; and
a first network name presence indicator data field corresponding to the first core network; and
broadcasting the core-network availability system information message to wireless user terminal devices via a first predefined over-the-air (OTA) signaling interface,
wherein the first network name presence indicator data field notifies the wireless user terminal devices whether a first human readable network name (HRNN) corresponding to the first core network is obtainable from a separate system information message transmitted by the wireless access network node.

2. The method of claim 1, wherein:
the first core network comprises a first standalone non-public core network (SNPN); and
the first network identifier comprises a first pair of network indicators comprising a first public network identifier and a first private network identifier associated with the first SNPN.

3. The method of claim 2, wherein the core-network availability system information message comprises:
a second network identifier associated with a second SNPN that connects to the wireless access network node and shares the wireless access network node with the first SNPN; and
a second network name presence indicator data field corresponding to the second SNPN,
wherein the second network name presence indicator data field notifies the wireless user terminal devices whether a second human readable network name (HRNN) corresponding to the second SNPN is obtainable from the separate system information message transmitted by the wireless access network node.

4. The method of claim 3, wherein:
the second network identifier comprises a second pair of network identifiers comprising a second public network identifier and a second private network identifier associated with the second SNPN;
the first public network identifier and the second public network identifier are identical; and
the first private network identifier differs from the second private network identifier.

5. (canceled)

6. The method of claim 1, wherein the first core network comprises a closed access group (CAG) within a public core network, wherein the CAG is configured to exclusively provide wireless network access to a closed group of mobile user devices, and wherein the first network identifier comprises a first pair of network indicators comprising a public network identifier and a closed-access-group network identifier associated with the CAG.

7. (canceled)

8. The method of claim 1, further comprising:
generating, as the separate system information message, an HRNN system information message that is distinct from the core-network availability system information message, wherein the HRNN system information message comprises the first HRNN corresponding to the first core network when the first network name presence indicator data field of the core-network availability system information message indicates that the first HRNN corresponding to the first core network is obtainable from the HRNN system information message; and
broadcasting or unicasting the HRNN system information message to the wireless user terminal devices via a second predefined OTA signaling interface distinct from the first predefined OTA signaling interface.

9. The method of claim 8,
wherein:
the HRNN system information message comprises:
a list of HRNNs; and
an index for each HRNN in the list of HRNNs identifying a corresponding core network having the HRNN;
each HRNN comprising a network identifier of the corresponding core network; or
wherein:
the HRNN system information message comprises a HRNN array of predetermined number of ordered components corresponding in pre-ordered one-to-one manner to a set of core networks sharing the wireless access network node; and
each ordered component of the HRNN array is set with an HRNN of the corresponding core network or is set with an empty component when no HRNN can be identified for the corresponding core network.

10. (canceled)

11. (canceled)

12. The method of claim 9, wherein:
the list of HRNNs comprises a first sub-list of HRNNs and a second sub-list of HRNNs;
the first sub-list of HRNNS correspond a first subset of core networks; and
the second sub-list of HRNNs correspond to a second subset of core networks exclusively supporting a closed access group of wireless terminal devices.

13. The method of claim 1, wherein:
the first network name presence indicator data field comprises a single bit; or
the first network name presence indicator data field comprises a first bit and a second bit, wherein the first bit is configured to indicate whether the HRNN corresponding the first core network is present when the first core network comprises an SNPN, and the second bit is configured to indicate whether the HRNN corresponding the first core network is present when the first core network comprises a private core network within a public core network for providing exclusive access to a closed access group of wireless terminal devices.

14. (canceled)

15. The method of claim 1, wherein the core-network availability system information message further comprises a list of single network slicing selection assistant information associated with the first core network.

16. The method of claim 1, wherein:
the first core network comprises a private core network; and
wherein the core-network availability system information message further comprises:
a voice/IMS emergency service indicator data field that indicates whether the private core network supports a voice/IMS emergency service;
a global voice/IMS emergency service indicator data field that indicating whether a group of private core networks sharing the wireless access network node support a voice/IMS emergency service; or an eCall over IMS indicator data field that indicates whether the private core network supports an eCall over IMS service; or
an eCall over IMS indicator data field that indicates whether a group of private core networks sharing the wireless access network node support an eCall over IMS service.

17.-19. (canceled)

20. A method performed by a wireless terminal device, comprising:
searching for service availability of a predetermined list of private core networks to identify a subset of available private core networks among the predetermined list of private core networks;
identifying a wireless access network node that is available to provide network connection to one or more of the subset of available private core networks;
receiving a core-network availability system information message broadcasted from the wireless access network node, wherein the core-network availability system information message comprises:
a set of network identifiers corresponding to the one or more of the subset of available private core networks; and
a set of network name presence indicator data fields; and
determining, based on the set of network name presence indicator data fields and the set of network identifiers, which of the one or more of the subset of available private core networks are associated with human readable network names (HRNNs) obtainable from an HRNN system information message transmitted by the wireless access network node separately from the core-network availability system information message.

21. (canceled)

22. The method of claim 20, further comprising:
upon determining that an available private core network among the one or more of the subset of available private core networks are associated with HRNNs obtainable from the HRNN system information message:
receiving the HRNN system information message; and
extracting an HRNN associated with the available private core network,
wherein core-network availability system information message is broadcasted by and the HRNN system information message is broadcasted or unicasted by the wireless access network node via a first over-the-air (OTA) signaling interface and a second OTA signaling interface distinct from the first OTA signaling interface, respectively.

23. The method of claim 20, further comprising:
upon determining that a group of available private core networks among the one or more of the subset of available private core networks are associated with HRNNs obtainable from the HRNN system information message:
transmitting an HRNN request message to the wireless access network node to trigger the wireless access network node to transmit the HRNN system information message;
receiving the HRNN system information message; and
extracting a set of HRNNs associated with the group of available private core networks from the HRNN system information message;
wherein the core-network availability system information message, the HRNN request message, and the HRNN system information message are transmitted via distinct OTA signaling interfaces.

24.-29. (canceled)

30. The method of claim 20, wherein:
the core-network availability system information message further comprises one or more voice/IMS emergency support indicator data fields corresponding to the one or more of the subset of available private core networks for indicating whether a voice or IMS emergency service is supported by the one or more of the subset of available private core networks, or one or more network slicing support indicator data fields corresponding to the one or more of the subset of available private core networks and indicating whether one or more single network slices are supported by the one or more of the subset of available private core network; and
the method further comprises extracting the one or more voice/IMS emergency support indicator data fields or network slicing support indicator data fields from the core-network availability system information message for further processing by an upper layer of the wireless terminal device.

31. The method of claim 30, wherein the one or more voice/IMS emergency support indicator data fields:
Comprise a single voice/IMS emergency support data field for indicating that the one or more of the subset of available private core networks support the voice or IMS emergency service; or
have a one-one correspondence to the one or more of the subset of available private core networks.

32. (canceled)

33. The method of claim 20, wherein the
the core-network availability system information message further comprises one or more eCall-over-IMS support indicator data fields corresponding to the one or more of the subset of available private core networks and indicating whether an eCall-over-IMS service is supported by the one or more of the subset of available private core networks; and
the method further comprises extracting the one or more eCall-over-IMS support indicator data fields from the core-network availability system information message for further processing by an upper layer of the wireless terminal device,
wherein the one or more eCall-over-IMS support indicator data fields:
comprise a single eCall-over-IMS support indicator data field for indicating that the one or more of the subset of available private core networks support the eCall-over-IMS service; or
have a one-one correspondence to the one or more of the subset of available private core networks.

34. (canceled)

35. (canceled)

36. (canceled)

37. The method of claim 30, wherein the one or more network slicing support indicator data fields:
Comprise a single network slicing support indicator data field for indicating that the one or more of the subset of available private core networks support one or more single network slices; or
have a one-one correspondence to the one or more of the subset of available private core networks.

38. (canceled)

39. A method performed by a wireless terminal device, comprising:
searching for service availability of a predetermined list of private core networks to determine a subset of available private core networks among the predetermined list of private core networks;
selecting a wireless access network node available to provide network connection to one of the subset of available private core networks;
receiving a core-network availability system information message broadcasted from the wireless access network node, wherein the core-network availability system information message comprises:
a network identifier corresponding to the one of the subset of available private core networks; and
one of:
a voice/IMS emergency support indicator data field corresponding to the one of the subset of available private core networks and indicating whether a voice or IMS emergency service is supported by the one of the subset of available private core networks;
an eCall-over-IMS support indicator data field corresponding to the one of the subset of available private core networks and indicating whether an eCall-over-IMS service is supported by the one of the subset of available private core networks; or
a network slicing support indicator data field corresponding to the one of the subset of available private core networks and indicating whether a network slicing service is supported by the one of the subset of available private core networks;
determining, based on the network identifiers, and one of the voice/IMS emergency support indicator data field, the eCall-over-IMS support indicator data field, or the network slicing support indicator data field, whether the one of the subset of available private core networks supports the voice or IMS emergency service, the eCall-over-IMS service, or the network slicing service; and
extracting the voice/IMS emergency support indicator data field, the eCall-over-IMS support indicator data field, or the network slicing support indicator data field from the core-network availability system information message and forwarding to an upper layer in the wireless terminal device for further processing.

40. A communication device comprising one or more processors and one or more memories, wherein the one or more processors are configured to read computer code from the one or more memories to implement the method of claim 20.

41. (canceled)
